(19) United States
(12) Patent Application Publication
(10) Pub. No.: US 2026/0260058 A1
(43) Pub. Date: Sep. 3, 2026

(54) AUTOMATIC ELECTRONIC DOCUMENT REVIEW AND REPORT

(71) Applicant: BOLD Limited, Hamilton (BM)

(72) Inventors: Abhishek CHAUHAN, Noida (IN); Mohit Kumar GOEL, Greater Noida (IN); Wendy YOUNG, Louisville, KY (US); Sandeep GUPTA, Noida (IN)

(21) Appl. No.: 19/069,141

(22) Filed: Mar. 3, 2025

(51) Int. Cl. G06F 40/186

(52) U.S. Cl. CPC G06F 40/186

(57) ABSTRACT

Certain aspects of the present disclosure provide techniques for electronic document review and revision. A method for document review includes obtaining an electronic document comprising a plurality of sections of text; for one or more of the plurality of sections, selecting, from a plurality of sample electronic documents, a set of text samples corresponding to respective ones of the plurality of sections; generating a prompt to guide a large language model, wherein the prompt comprises: the text samples corresponding to the respective ones of the plurality of sections, target text associated with the respective ones of the plurality of sections, and instructions for the large language model to review the target text based on the text samples; sending, to the large language model, the prompt; obtaining, from the large language model, a response based the prompt; and outputting one or more revisions to the target text based on the response.

### INTRODUCTION

### Technical Field

The present specification relates to systems and methods for electronic document review and revision.

### BACKGROUND

Electronic documents are frequently submitted by users through a document submission system (e.g., a website or other online system) for review and processing. By way of example, a job seeker will typically prepare a precisely formatted resume, cover letter, job application, or the like (e.g., as a Microsoft® Word DOCX or Adobe Acrobat® PDF file) that they may upload and submit as part of an online job application (e.g., through an employer's website, a job application board, a social media platform, or the like). The application, including the documents uploaded by the job seeker, will frequently be forwarded to and processed through an applicant tracking system (ATS), or other document review system, which may allow a recruiter or human resources (HR) personnel at a hiring entity to review the application and take appropriate action (e.g., contacting the job applicant to schedule an interview, requesting additional information, etc.). The ATS may process the uploaded documents in order to facilitate review by the recruiter or human resource (HR) personnel, for example, by generating a document “preview” that the recruiter may view and interact with through a portal provided by the ATS system.

There is an opportunity to improve electronic document review and revision processes, which are typically reliant on manual, time-consuming processes that are resource intensive, for example, requiring significant human capital.

### BRIEF SUMMARY

One aspect provides a method for document review, includes obtaining an electronic document comprising a plurality of sections of text; for one or more of the plurality of sections, selecting, from a plurality of sample electronic documents, a set of text samples corresponding to respective ones of the plurality of sections; generating a prompt to guide a large language model, wherein the prompt comprises: the set of text samples corresponding to the respective ones of the plurality of sections, target text associated with the respective ones of the plurality of sections, and instructions for the large language model to review the target text based on the set of text samples; sending, to the large language model, the prompt; obtaining, from the large language model, a response based the prompt; and outputting, to a user device, one or more revisions to the target text based on the response.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### DESCRIPTION OF THE DRAWINGS

The aspects set forth in the drawings are illustrative and exemplary in nature and are not intended to limit the subject matter defined by the claims. The following detailed description of the illustrative aspects can be understood when read in conjunction with the following drawings, where like structure is indicated with like reference numerals and in which:

FIG. 1 depicts an example electronic document system configured to perform review and revision processes for electronic documents, according to one or more aspects shown and described herein.

FIG. 2 depicts an illustrative review and revision process, according to one or more aspects shown and described herein.

FIG. 3 depicts an illustrative interface for reviewing a revised electronic document generated by the one or more LMs, according to one or more aspects shown and described herein.

FIG. 4 depicts another illustrative interface for reviewing a revised electronic document generated by the one or more LMs, according to one or more aspects shown and described herein.

FIG. 5 depicts a flowchart of a method for reviewing and revising an electronic document, according to one or more aspects shown and described herein.

FIG. 6 depicts an example computing device configured to perform processes of the electronic document system, according to one or more aspects shown and described herein.

### DETAILED DESCRIPTION

Aspects of the present disclosure provide apparatuses, methods, processing systems, and computer-readable mediums for automating review and revision processes for electronic documents, such as resumes, cover letters, job applications, and the like. Electronic document review and revision techniques described herein utilize specially programmed processing device(s) and advance the capabilities of a language model. In certain aspects, the language model may be configured to automate review of electronic documents and generate revisions for the electronic document, which may be automatically implemented in certain aspects.

Electronic documents may be manually drafted by a user, generated through the assistance of document creation tools, or combinations thereof. Regardless of the electronic document creation process that is utilized, the electronic documents may be further processed for review and revision with the electronic document review and revision techniques described herein. The electronic document may contain a plurality of sections, such as in the case of a resume, a job title, experience level corresponding to the job title, one or more work history statements, and/or the like. The electronic document review and revision techniques described herein can assess an electronic document for relevant content, quality, and format in a section-by-section approach or as an entire electronic document. The electronic document review and revision techniques described herein employ a language model (LM), which is one or more language models unless specifically indicated herein, and leverage in-context learning techniques based on text samples selected from a curated database of text samples to tailor review and revision suggestions by section of the electronic document.

The text samples within the curated database of text samples may be organized to correspond to sections of electronic documents and are exemplary of high-quality content, formatting, writing style, tone, and/or the like. These text samples may be a collection of material from previously reviewed and revised electronic documents. The text samples may have been manually processed or analyzed with a rule-based process to increase the certainty that the content in the curated database includes high-quality samples that may be leveraged by future review and revision process carried out by the language model employed by electronic document review and revision techniques described herein.

The utilization of text samples that correspond to sections of the electronic document selected from the curated database of text samples enables the language model to provide improved contextual understanding when prompted to review one or sections of the electronic document compared to a language model that is not prompted with the text samples. For example, in certain aspects, the curated dataset includes structured data and/or metadata. For example, the curated dataset may include a column, such as a column titled by “section name,” which serves as a key for filtering. For each section, the dataset may be directly filtered using the corresponding section name ensuring that the dataset contains only samples relevant to that specific section. Following the filtering step, filtered text samples may be randomly selected and inserted into the prompt. In some aspects, section names and other content of the curated database may be indexed as separate vectors to enable fine-grained queries for text samples that are related to sections of the electronic document to be reviewed and revised. As such, for example, in response to a query, the text sample component of the electronic document creation process may return a set of text samples that have the same or similar section names as the sections of the electronic document to be reviewed and revised and provide the set of text samples to the language model.

That is, the text samples provide the language model with context for particular sections of the electronic document being reviewed. The utilization of text samples further enable the language model to generate coherent responses, such as suggested revisions to the one or more sections that can address context specific attributes including, but not limited to, content, formatting, writing style, tone, and/or the like for a section of the electronic document.

For example, a prompt provided to the language model may include an instruction to review and provide suggested revisions to the writing style of a work history statement based on the included text samples. In this example, the language model may ascertain the writing style, or the most common writing style, employed in the text samples, and then review and provide a suggested revised text output for the work history statement that implemented the writing style ascertained from the text samples. This is merely one example relating to the utilization of text samples to guide the language model. It should be understood that by prompting a language model in this manner, numerous prompts each with different instructions for a language model do not need to be developed. That is, the permutation of prompts that would otherwise need to be developed and then manually selected at a minimum would include the number of different writing styles that could be employed. The permutation of prompts increases as each section of an electronic document and type of electronic document may employ a different or a select number of writing styles. Additionally, the writing style for a particular electronic document may differ based on the type of job a user may be creating the electronic document for use.

In contrast, the electronic document review and revision techniques described herein implement an approach that utilizes a prompt that instructs the language model to perform a review of the electronic document based on text samples from the curated database. By basing the language model review on the text samples, the text samples provide the language model with domain specific guidance instead of explicitly defining and providing instructions through the prompt provided to the language model. This approach further improves the flexibility, scalability, and customization of electronic document review and revision because the selected text samples are configured to provide content specific guidance to the language model performing the review and revisions processes. In other words, the text samples that are included in the curated database of text samples and selection of the text samples that correspond to respective sections of the one or more sections of the electronic document provide the language model with content, formatting, writing style, tone, and/or the like to follow. For example, flexibility, scalability, and customization of electronic document review and revision does not require the redesign of prompts or creation of new prompts for new types of electronic documents or changes to the content, formatting, writing style, tone, and/or the like of a section of an electronic document. Instead, the flexibility, scalability, and customization of electronic document review and revision can be achieved merely through the selection text samples from the curated database of text samples that correspond with the respective sections of the one or more sections of the electronic document that the language model is instructed to review and generate revisions.

In certain aspects, electronic document review and revision techniques may include obtaining the electronic document, for example, in response to a request for review of the electronic document, optionally from another document creation system or directly from a user interacting with the electronic document review and revision system. In certain aspects, the electronic document review and revision system may identify and select a set of text samples from the curated database of text samples. The selection process may include identifying and selecting text samples from the same type of electronic document as the electronic document that is submitted for review. For example, if the electronic document is a resume, then text samples are selected from the curated database of text samples of other resumes. Furthermore, the selection process may include identifying and selecting text samples from sections with the same or related section title, for example, but not limited to utilizing metadata associated with the text samples in the curated database. For example, text samples selected for review of a work history summary section of the electronic document include text samples from “work history summary” sections or related sections like “job history summary,” “work experience narrative,” or similarly titled section(s) of past electronic documents that have been curated in total or in part into the curated database of text samples.

In certain aspects, the language model may be a large language model, a small language model, or other language model. The language model may be guided by a prompt to ingest the selected text samples, the targeted text for review from the electronic document, and instructions to provide a review of the targeted text based on the selected text samples. The instructions to review the targeted text based on the selected text samples include instructions for the language model to ascertain one or more attributes, such as content, format, writing style, tone, and/or the like from the text samples. The ascertained attributes may be utilized during review of the targeted text and generation of one or more revisions to the targeted text by the language model. For example, the instructions to ascertain attributes from the selected text samples may include carrying out an in-context learning (ICL) process, which may also be referred to as few-shot learning. The prompt may indicate which of the one or more attributes that the language model should focus on ascertaining from the selected text samples. The aforementioned techniques can enable the language model to adapt its responses to better fit the context of the targeted text and/or the electronic document being reviewed, compared to responses provided by language models that are not provided context through the selected text samples. For example, the responses, which include one or more revisions to the targeted text, may align with attributes expressed by the selected text samples.

In certain aspects, the response from the language model may comprise recommendations to update the targeted text in the electronic documents, and be provided through a computer-generated interface to the user. In some aspects, the recommendations, which may be revisions of the targeted text, may be automatically implemented to generate an updated version of the electronic document, which may then be returned to the user through the computer generated interface and/or automatically provided to other downstream processing systems, such as application processing systems, document retention system, and/or the like.

Current document review and revision processes, such as resume review services, utilize human personnel trained to follow a set of criteria and apply their error proofing skills to review and revise the electronic document. These current document review and revision processes are both time-consuming and resource-intensive, thus limiting scalability and making it difficult to handle a large volume of reviews within a reasonable timeframe without compromising feedback quality. Additionally, the ability to maintain a sufficient number of workers to handle service demands at scale can be cost prohibitive for a company. Hiring and training workers to accommodate order volumes, which can fluctuate greatly, can be challenging because human personnel need to be trained on review and revision criteria, which can change or be specific to the various types of electronic documents and/or sections of the electronic documents submitted for review and revision. Furthermore, managing workers, such as increasing or decreasing the number of workers employed for reviewing tasks, can be challenging and often adds to an organization's expenses.

Additionally, current document review and revision processes rely on limited criteria, templates, and training of the human reviewers to accurately conduct review of the electronic documents, which poses operational risks like delays in providing a response to a review and revision of an electronic document, missed requests for review of an electronic document, and inaccuracies. Since many of the current document review and revision processes rely heavily on human personnel, electronic document review and revision processes are prone to errors, such as missed spelling, grammar, and punctuation corrections and recommendations for revisions that may no longer be relevant when human personnel are not up to date on training.

Thus, there is a need to provide electronic document review and revision techniques that are capable of performing review of electronic documents that is accurate, reliable, cost-effective, and able to be performed in real-time or near real-time following submission of the electronic document for review. As used herein, the term “near real-time” refers to events occurring slightly slower than real-time, which refers to instantaneous or action happening at once. The term “near-real time” may include a margin of time required for processing to be carried out with a computing device, which in the certain aspects may be time to generate a response to the request for review of the electronic document.

Electronic document review and revision techniques described herein provide automated electronic review processes enabled by language models, which improve the handling, efficiency, and scalability of electronic document review and revision, and provide better productivity and quality or review when compared to current document review and revision processes, for example, that rely on human personnel to complete review and revision of documents. Additionally, the electronic document review and revision techniques do not merely utilize a language model prompted to review and generate recommended revisions to targeted text of the electronic document. Instead, the electronic document review and revision techniques described herein provide automated review and revision of targeted text with a language model configured to determine context for the review and revision processes from selected text samples so that the recommendations for revisions are more accurate, reliable, and timely than current document review and revision processes and mere utilization of language models. In certain aspects, techniques for guiding language models with selected text samples can improve the ability of an electronic document review and revision system to scale between handling small and large volumes of electronic document review and revisions with accuracy, reliability, and speed, which is not possible with current document review and revision processes.

Additionally, the electronic document review and revision techniques described herein can provide economic advantages for a company such as the reduction in costs associated with current document review and revision processes. The techniques also provide the benefit of improving user satisfaction and trust by providing accurate, reliable, and timely responses to a request for review of electronic documents. The rapid and precise feedback mechanism significantly enhances the user experience by allowing advice to be delivered quickly. The technical solutions provided by the automated electronic document review and revision techniques described herein are also an advancement in operational capability and service quality of electronic document review and revision.

### Example Electronic Document Review and Revision System

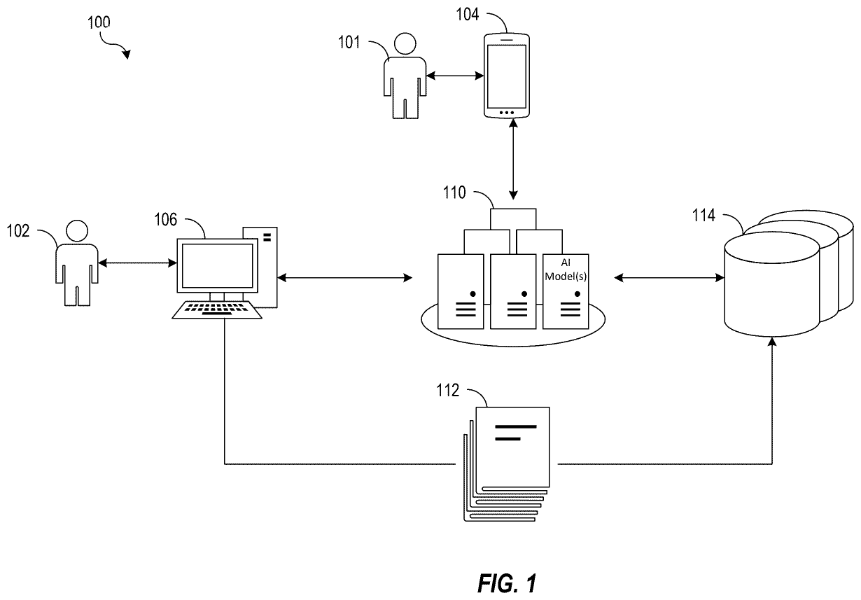

FIG. 1 depicts an example electronic document system 100 configured to perform review and revision of part (e.g., a section of) or all of an electronic document, and optionally other processes such as document creation. The electronic document system 100 may be configured to interface with one or more users (e.g., a first user 101 and second user 102) to generate a document and/or review and revise a document, such as a resume, cover letter, a job application, or the like. The document may be an electronic document, a component of an online profile, a printable document, or another type of document that a user may desire to create. The one or more users may include a job seeker, an employer, a reviewer, an administrator, or the like. The one or more users may interface with aspects of the electronic document system 100, for example implemented by one or more computing devices 110, through a user device (e.g., a first user 101 with a first device 104 and a second user 102 with a second device 106).

For example, a first user 101 may be a user desiring to create a resume for submitting with a job application. The first user 101 may interface with the electronic document system 100 via a first device 104, such as a personal computer, a cellular telephone, a PDA, smart device, or the like. A second user 102 may be an administrator whose role may be to collect and curate electronic documents that make up the plurality of sample electronic documents 112. The plurality of sample electronic documents 112 may be stored in one or more curated databases 114 that can be used by the language model for review and revision processes described herein. The plurality of sample electronic documents 112 may be documents that were reviewed, revised, and determined to include text samples that correspond to sections of electronic documents and are exemplary of high-quality content, formatting, writing style, tone, and/or the like for respective sections of electronic documents. The plurality of sample electronic documents 112 may have various templates and content that can be used to inform the language model when prompted to review an electronic document. As discussed herein, the language model can be informed or guided by selected text samples from the plurality of sample electronic documents 112, for example, through one or more techniques, such as in-context learning. The administrator may define one or more rules regarding which electronic documents may qualify as sample electronic documents for future review processes. For example, the plurality of sample electronic documents 112 may be required to be from a period of time defining a historical data range. For example, a historical data range may only include electronic documents that were input into the system within the past 1, 2, or 3 years, or other defined periods of time. A goal of establishing rules regarding the collection and curation of historical data is to provide a measure of quality and relevance to the data considered for the electronic document review and revision techniques described herein.

The first device 104 and/or the second device 106 may include a display device for implementing a user interface for a respective user, one or more processors for executing logic and one or more non-transitory computer-readable mediums for storing information and/or computer readable instructions. The first device 104 and/or the second device 106 may operate as an interface for interacting with processes of the electronic document system 100 configured to provide recommended revisions to targeted text of an electronic document as depicted and described herein. In certain aspects, electronic document review and revision processes carried out by the electronic document system 100 may be performed by one or more computing devices 110. The one or more computing devices 110 may include one or more processors and one or more non-transitory computer-readable mediums storing computer readable instructions that, when executed by the one or more processors, cause the computing device to perform processes defined by computer-readable instructions corresponding to one or more components depicted and described herein.

The one or more computing devices 110 may be configured to implement one or more AI models such as one or more machine learning models including, but not limited to, one or more language models (LMs), for example including large language models (LLMs) and/or small language models (SLMs). Examples of LMs include, but are not limited to, OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more LMs currently developed or that may be developed in the future. In certain aspects, the one or more AI models may include one or more NLP models, such as stsb-roberta-large, paraphrase-mpnet-base, gtr-t5-large or other sentence transformer models.

### Example Electronic Document Processes Including Review and Revision Processes

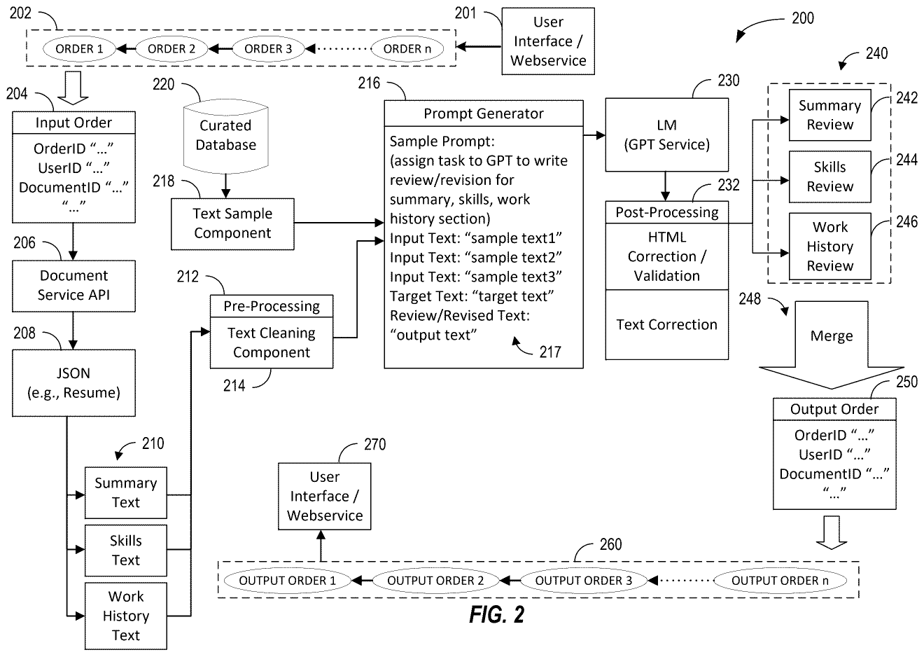

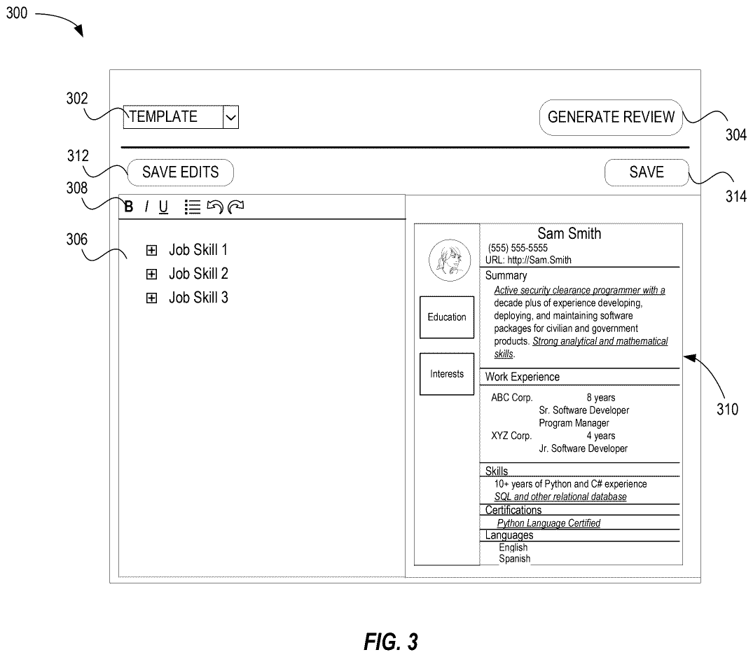

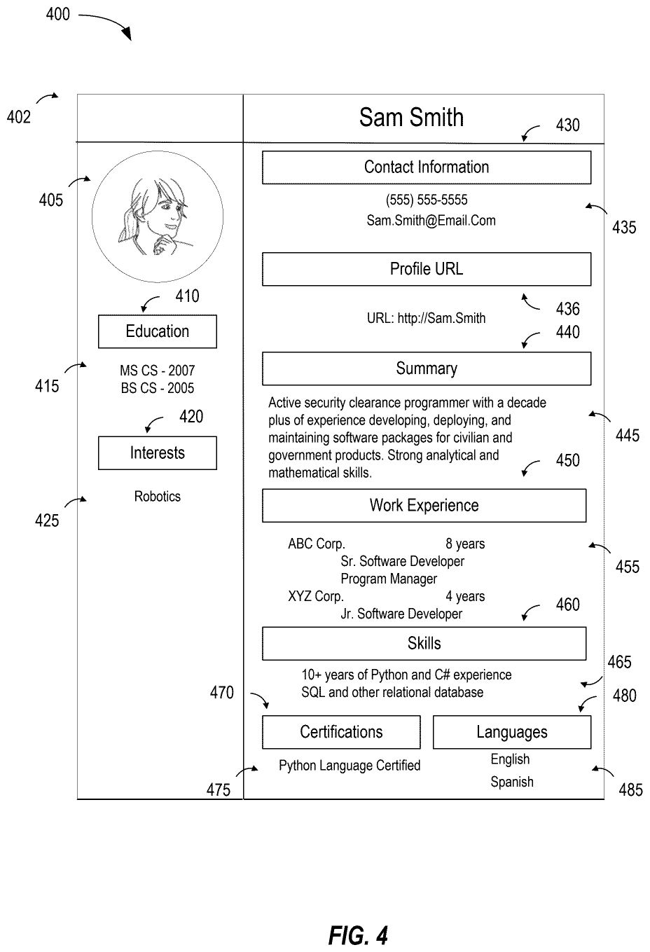

FIG. 2 depicts an electronic document review and revision process 200, optionally implemented by the electronic document system 100. The electronic document system 100 may deploy one or more user interfaces to a user device (e.g., the first device 104 and/or the second device 106), examples of which are depicted and described with reference to FIGS. 3 and 4. A user (e.g., the first user 101 or the second user 102) may input an order 202 (e.g., a request) for review of an electronic document (e.g., the electronic document 402 depicted and described with reference to FIG. 4).

In certain aspects, the electronic document system 100 may receive multiple orders 202. The orders 202 may be received from various users, for example, the first user 101 or the second user 102 from a user interface or web service 201. The orders 202 may be queued with a storage service, such as a cloud storage service, including but not limited to Azure™ Blob Storage, for example. As the electronic document system 100 processes the orders 202, respective orders 202 may be received from the queue by the electronic document system 100.

A received order 204, which is one of the multiple orders 202 from the queue, may include various information to facilitate a review and revision process of an electronic document. For example, the received order 204 may include information such as a user identification, which may be a user's username or other identifier that relates a user to a profile and/or one or more electronic documents. The received order 204 may include one or more document identifiers. The one or more document identifiers may be a reference number, file name, or the like that the electronic document system 100 may utilize to obtain the one or more electronic documents. In some aspects, the received order 204 may include a data file or a file location corresponding to an electronic document that the user has identified for review and revision with the electronic document review and revision process 200. In some aspects, the received order 204 may include additional information such as comments or instructions regarding particular sections of the electronic document that should be reviewed by the electronic document review and revision process 200. In some instances, the additional information may include a reference to a job application or a job posting that the user desires to submit their electronic document (e.g., resume, cover letter, etc.). For example, the job application or the job posting may contain additional context information for the review process, such as indications as to what skills, qualifications, or other attributes that a specific job is seeking. The additional context information may be included with the prompt to the LM 230, which may be one or more LMs, unless indicated otherwise, with instructions for the LM 230 to determine context from the additional context information. The context information enables the review process of the electronic document to be tailored to provide the user with recommended revisions that are relevant to the specific job. In some aspects, the electronic document review and revision process 200 may be configured to revise the electronic document to recite and/or conform, for example, skills, qualifications, work history or the like to better fit and/or align with a description of a candidate or requirements for the specific job. For example, better fit and/or alignment may refer to causing the LM 230 implemented by the electronic document review and revision process 200 to incorporate keywords, skills, and/or other qualifications that were determined from the additional context information into the electronic document. The electronic document review and revision process 200 may not only suggest or automatically incorporate relevant terms, but may also revise language usage, writing style, and/or tone of the text discussing a user's qualifications, skills, or the like so that the text of the electronic document is a better fit to the specific job posting, for example.

The electronic document system 100 may be configured to obtain an electronic document, such as a resume, cover letter, or the like from a data storage or data upload location based on the received order 204. The electronic document system 100 may utilize a document service application programing interface (API) 206 to access, retrieve, obtain, or otherwise receive from a data storage component, such as one or more memories of the electronic document system 100 or a communicatively coupled cloud data store or server, the electronic document.

In some aspects, the document service API 206 may cause the electronic document to be formatted or structure into a JavaScript Object Notation (JSON) or other text-based structured format for storing and/or exchanging data. The structuring process may be performed by the electronic document system 100 or a secondary system that is communicatively coupled with the electronic document system 100. The structuring process of the electronic document may be performed locally by the electronic document system 100 or externally by the secondary system. The structuring process of the electronic document may include implementation and utilization of one or more artificial intelligence (AI) models, such as an LM or other model, or a document conversion or structuring component that is configured to ingest an electronic document in a first format and output in a second format, such as a JSON formatted document. The structuring process of the electronic document may include annotating various portions of the electronic document as corresponding to one or more sections. For example, an electronic document, such as a resume, may include a summary text section, a skills text section, a work history text section, an education text section, and/or other sections. The structuring process may parse these sections from the other text sections and annotate them respectively.

In certain aspects, an extraction component 210 may extract the sections of text from the electronic document based on the annotated sections and provide the sections of text respectively, or optionally as a complete document, into a pre-processing component 212. The pre-processing component 212 may include one or more sub-components that are configured to address errors in the text or formatting of the electronic document, optimize text for processing with LM 230, and/or the like. For example, the pre-processing component 212 may include a text-cleaning component 214. The text-cleaning component 214 may be configured to optimize text of one of the plurality of sections of text in the electronic document for the LM 230. For example, the pre-processing component 212, or one of the sub-components such as the text-cleaning component 214, may include processes for removing punctuation and/or non-alphabetic characters, converting text to lower case, title case, or all caps, expanding contractions, removing accents and/or diacritics, removing whitespaces or including consistent spacing, eliminating tags, such as HTML tags, reducing words to their root, and/or other processes that prepare, optimize, or transform text into a cleaner or more structured format for review and revision processing. In some aspects, a pre-processing component 212 may not be utilized by the electronic document review and revision process 200. The text-cleaning component 214 may be configured to remove or adjust features of the text that may troublesome for the LM 230 to handle.

In certain aspects, the electronic document review and revision process 200 may continue with generating a prompt 217 to guide the LM 230. A prompt generator component 216 may perform generation of the prompt 217. The prompt generator component 216 may be configured to perform one or more various operations that enable the LM 230 to perform a desired operation, such as reviewing and/or revising an electronic document. The prompt generator component 216 may include one or more template prompts that may be populated with information and instructions. For example, a template prompt may include one or more fields to be populated. A first field of the prompt 217 may include instructions that define and/or assign one or more tasks to the LM 230. For example, the first field may include instructions configured to cause the LM 230 to review, revise, and/or generate revisions or a revised electronic document. The first field may include instructions that indicate how the LM 230 is to conduct the review. For example, the instructions may cause the LM 230 to review one or more sections of text, referred to herein as targeted text, based on a set of text samples that are fed into the LM 230 with the electronic document to review and revise.

A second field of the prompt 217 may include the set of text samples as text strings or provide file locations from which the LM 230 may retrieve the set of text samples. For example, the set of text samples may be provided to the prompt generator component 216 by the text sample component 218, which is described in more detail herein. Respective ones of the set of text samples may be accompanied by an annotation indicating to which portion of the electronic document the respective ones of the set of text samples correspond. For example, one or more text samples of the set of text samples may correspond to the respective sections of the electronic document, such as the job title section, a job skills summary section, a work history summary section, and/or the like.

A third field may include the electronic document, for example, in a structured format such as a JSON format, or provide the file location from which the LM 230 may retrieve the electronic document for processing. In some aspects, the third field may indicate the target text for review whether the target text is the entire electronic document or one or more sections of the electronic document. In some instances, an entire electronic document may be fed into the LM 230 so that the LM 230 may have comprehensive context of the electronic document, while being instructed to review and revise indicated sections of the one or more sections of the electronic document. For example, by providing the electronic document to the LM 230, the LM 230 may obtain, for example through a filtering process, a profile of the user, such as a summary of the user's education and/or work history, which may aid the LM 230 in performing review and revisions of the indicated sections for review and revision such as the skills section or the brief summary section.

In some aspects, the prompt 217 may include instructions that cause the LM 230 to execute an in-context learning (ICL) process, which may also be referred to as few-shot learning process. The few-shot learning process may cause the LM 230 to tailor their review and revision of the electronic document more specifically in view of the text samples that are provided to the LM 230. The few-shot learning process can enable in-context learning by the LM 230 based on the text samples provided with the prompt 217 to advance the model such that the LM 230 performs better with respect to the tasks of reviewing and revising. That is, the review and revision processes carried out by the LM 230 may generate and/or automatically incorporate revisions that are more similar to the text samples provided with the prompt 217, thus guiding the revisions to be more aligned with content expected for the specific review context. For example, as discussed herein, the review context is directed to helping a user review and revise an electronic document, such as a resume or a cover letter for a job application. While this may not always be the case, the set of text samples that are provided may be from other resumes or cover letters that contain formats, content, language, and the like that is exemplary for a particular job application, for example.

As an illustrative example, the set of text samples corresponding to a particular section of the electronic document, such as a skills section, may provide attributes, which can be determined by the LM 230, into writing styles and writing tone that are more applicable to expected or preferred style for the respective section(s) being reviewed and revised. For example, a writing style consisting of active voice as opposed to passive voice may be more desirable for a particular section of a resume. The set of text samples may enable the LM 230 to ascertain these attributes so that the LM 230 is configured to revise the language of that section to imitate and/or align the style more commonly utilized based on the text samples.

In some aspects, the prompt 217 may be configured to include other fields, such as a field that indicates one or more job applications or job postings that the electronic document is to be reviewed and revised for use. Similar to the set of text samples indicated or provided with the prompt 217, the one or more job applications or job postings may guide the LM 230 to review and revise the electronic document such that any revisions are relevant to the one or more job applications or job postings.

In certain aspects, the prompt generator component 216 may interact with a text sample component 218 that is configured to identify and select, from a plurality of sample electronic documents, the set of text samples corresponding to the respective sections of the electronic document for review by the LM 230. The text sample component 218 may be configured to utilize a filtering process, for example, based on column keywords and/or metadata indexing, to identify and select the set of text samples from the curated database stored in the data store component 220. The text sample component 218 may be configured to interface with a data store component 220, for example, a cloud-based data service to query and retrieve the set of text samples. The text sample component 218 may query the data store component 220 for text samples based on a variety of criteria. For example, the query may include section names of the one or more sections of the electronic document that are to be reviewed and revised. As such, the set of text samples with the same or similar section names may be returned as part of the set of text samples. In some aspects, the query for text samples may include document types such as resumes, cover letters, or job applications to be provided as part of the set of text samples. In some aspects, the query may include a date range so that text samples from within the date range are provided. The query generated and executed by the text sample component 218 with the data store component 220 may include one or more other attributes or keywords for identifying and selecting the set of text samples. The text sample component 218 may obtain information for the query from the received order 204, the job application or job positing, the electronic document, or other source. In some aspects, the selection of text samples for the set of text samples may be a random sample. In some aspects, the selection of text samples for the set of text samples may be set to a fixed number of total samples.

The set of text samples selected by the text sample component 218 may be provided to the prompt generator component 216, so the prompt generator component 216 can incorporate the set of text samples in the prompt 217. The prompt generator component 216 is further configured to send the prompt 217 to the LM 230 to execute the instructions provided in the prompt 217.

The LM 230 may be one or more large language models or one or more small language models (SLMs). That is, LM 230 is sometimes distinguished between a “large” LM and a “small” LM based on the size and complexity of the model, which affects their capabilities and applications. LLMs are often characterized by their large number of parameters, ranging from hundreds of millions to trillions of parameters. This extensive scale enables them to capture complex language patterns and nuances. LLMs are trained on vast datasets that often include diverse and extensive sources of text from the internet, books, articles, and various other textual corpora (e.g., domain-specific corpora). The large volume of training data contributes to their broad generalization capabilities. Due to their size and comprehensive training, LLMs exhibit excellent language understanding and generation abilities. Relatedly, LLMs require significant computational resources for both training and inference. This includes, for example, powerful hardware such as multiple GPUs or TPUs and substantial memory and storage capacity.

SLMs have a smaller number of parameters, compared to LLMs, often ranging from tens of thousands to a few hundred million parameters. This relatively smaller size bounds their ability to capture complex language patterns. SLMs are often trained on smaller datasets compared to LLMs. The training data is typically more focused and less diverse, aimed at specific tasks or domains. While SLMs can still perform various language-related tasks, their performance is usually limited compared to LLMs. However, SLMs require significantly fewer computational resources for training and inference. They can be run on more modest hardware setups, making them suitable for applications with constrained resources or where quick deployment is essential.

Thus, LLMs offer enhanced performance and versatility at the cost of higher computational resource requirements, while SLMs provide a more resource-efficient solution with limitations in performance and capabilities. The choice between an LLM and an SLM depends on the specific application requirements and resource constraints.

In certain aspects, the LM 230 may be generalized models or models developed for specific applications such as resume, cover letter, and job application review processes. The LM 230 may interface with one or more components of the electronic document review and revision process 200 and/or the electronic document system 100. The LM 230 may be implemented by the electronic document system 100. The LM 230 may further have communicative capability with data storage components, such as the data store component 220 for obtaining the set of text samples indicated by the prompt 217 or other data such as the electronic document from another data storage component, when not provided directly by the prompt 217. The LM 230 processes the set of text samples, instructions defined with in the prompt 217, and the electronic documents or sections thereof for review and revision. Parameters of the review of the electronic document may be broad instructions provided to the LM 230 in the prompt. For example, the LM 230 may be instructed to review the electronic document and revised or provide suggested revisions based on the set of text samples, and optionally, the job application or job posting. In such an instance, the LM 230 may proceed with addressing formatting, grammar, language usage, content, or other aspects to bring the electronic document in closer alignment with the set of text samples.

In certain aspects, multiple LMs 230 may implemented. In such aspects where multiple LMs 230 are employed, the configuration may depend on whether the output of one LM 230 serves as the input for another. If so, the LMs 230 would run in serial. Alternatively, if the goal is to obtain multiple responses from LMs 230 for mechanisms like voting, the LMs 230 could run in parallel. Additionally, specific LMs 230 may be configured to handle distinct review or revision tasks or focus on specific sections of the document based on the requirements.

In other instances, the LM 230 may be instructed to review one or more specific sections of electronic document and incorporate or provide suggested revisions that change the format or content of the electronic document so that it more closely matches format or content of the set of text samples. An advantage of implementing an LM 230 to conduct a review and provide revisions to the electronic document is the ability for a user to tailor how or what they would like to be reviewed and in what context (e.g., with respect to a specific format or job posting) the review and revisions should be made. The set of text samples, and optionally the job application or job positing, that are provided to the LM 230 provide additional guidance that can improve the accuracy and relevance of output of the LM 230.

The LM 230 may output suggested revisions to the targeted text of the electronic document or a revised electronic document. Regardless of the form that the content output by the LM 230 takes, a post-processing component 232 may be implemented in the review and revision process 200. The post-processing component 232 may include one or more post-processing sub-components. The post-processing component 232 may be configured to correct and/or validate embedded coding of the content that is output by the LM 230, perform text correction or format correction processes, and/or other post-processing operations. The post-processing operations may address potential issues introduced by the LM 230. The post-processing operations may be configured to perform a quality check on the content output by the LM 230. For example, the post-processing operations of the post-processing component 232 may include checking attributes such as the length of the content, punctuation, capitalization, consistency of contraction use, spacing, tagging or embedded data, or other aspects that may optimize or transform text into a cleaner or more structured format.

As noted herein, the content output 240 by the LM 230 may include individual sections of text with suggested revisions or a revised electronic document. For example, the individual sections of text may include text corresponding to a summary 242, skills 244, work history 246, or other section. The suggested revisions or the revised electronic document may be provided in a final clean form without any tracked changes or in a marked-up text form so that the user may visualize the revisions when presented in visual form. The marked-up text form can provide the user the option to accept, reject, or further modify the suggested revisions. In some aspects, the revised electronic document may be provided in a final clean form, but may include comments

In aspects where the content output 240 is provided as individual sections of text, the review and revision process 200 may include a merge component 248 that is configured to combine the revised sections into a revised electronic document. The merge component 248 may replace sections of the original electronic document provided for review with the respective individual sections of text generated by the LM 230. The revised electronic document may be packaged into an output order 250 for delivery back to the user. The output order 250 may incorporate the user identification information provided in the received order 204 and the revised electronic document, the suggested revisions to the electronic document, and/or the file location(s) for the same.

In certain aspects, the output order 250 may be queued with a document service 260, such as a cloud storage service, including but not limited to Azure™ Blob Storage, for sending to the user. In certain aspects, the document service 260 may configure the output order to be provided to the user via an electronic message, an interface, such as a display device, or other means of delivery to or retrieval by the user. In some aspects, the document service 260 may directly provide the output order 250 to a job posting or other job application system or service 270, thereby assisting a user with the completion of an application submission.

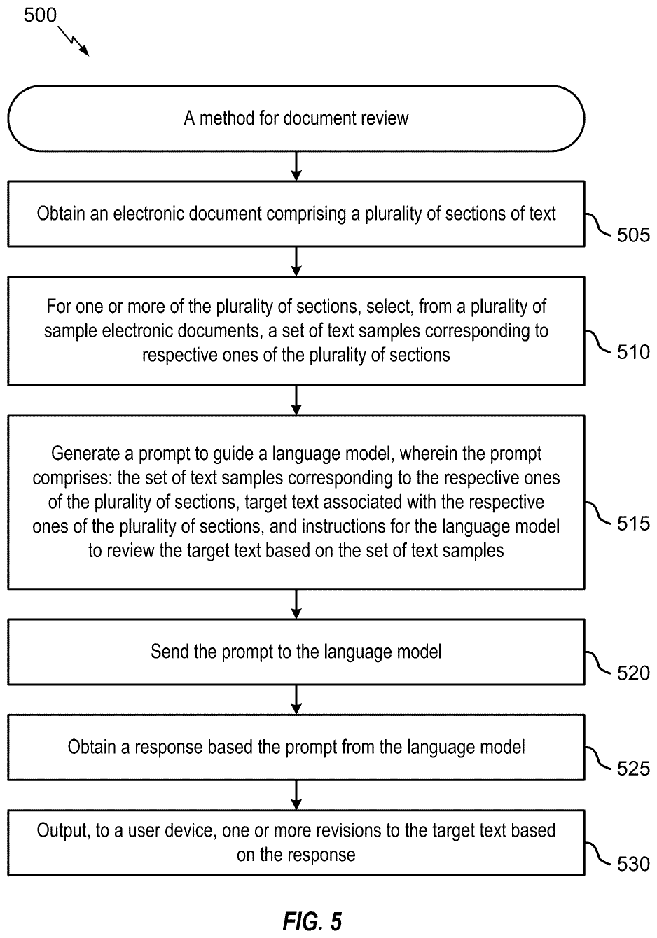

FIG. 3 depicts an illustrative interface 300 for reviewing a revised electronic document 310 generated by the LM 230. The revised electronic document 310 depicts some illustrative marked-up revisions to the language. These revisions are depicted in underline and italic formatting. The user may accept, reject, or further revise these revisions. The interface 300 shown in FIG. 5 may be a graphical user interface (GUI), however in the context of the present disclosure, it is understood that the interface 300 is not limited to a GUI, but rather may be implemented in other forms, such as spoken prompts, for example, which may be advantageous for users that are visually impaired. For brevity, the present disclosure will focus on a GUI version of the interface 300.

In certain aspects, the LM 230 may output suggested revisions to one or more sections of the revised electronic document 310. The interface 300 may be configured to present a revised electronic document 310 in a first portion of the interface and presented the suggested revisions or revisions that were automatically made to a particular section of the electronic document in a text edit box 306 of the interface 300 for the user to review and optionally edit further. For example, the first portion may be a preview pane automatically populated with the revised electronic document 310. The interface 300 may provide the user with the opportunity to further edit the revised electronic document 310. For example, the user may change the document type by selecting a template through an interactive element, such as a drop-down list box 302 and subsequently causing the selected template document to be generated by selecting button 304. The document template selected may be a resume (e.g., a full resume, a short-version resume, or other defined format for a resume), a job application, a cover letter, or the like. Content may be edited through the text edit box 306, which may include selectable items such as skills from an ordered list of skills. Content may be edited directly in the revised electronic document 310.

The text edit box 306 may provide text-editing tools 308, allowing the user to modify the text, add additional information, such as employment dates and the like, and rearrange the content. Additionally, the interface 300 may update the revised electronic document 310 based on edits made in the text edit box 306. A save edits button 312 is configured to save changes made to the content of a particular section of the electronic document shown in the text edit box 306, and a second save button 314 may be configured to save the revised electronic document 310 with the applied template shown in first portion. The revised electronic document 310 may be saved in any document format, such as PDF, DOCX, ODF, SVG, JPEG, and the like.

FIG. 4 depicts another illustrative interface 400 including an electronic document 402, such as a resume. The interface 400 may be implemented through a display device of the electronic document system 100, such as a display device of the first device 104 and/or the second device 106 as depicted and described with reference to FIG. 1. Interface 400 may be implemented by the electronic document system 100 and the review and revision process 200 described herein in a variety of ways. For example, the interface 400 may provide an interactive version of an electronic document 402 configured in a manner that enables a user to select one or more sections 405, 410, 420, 430, 440, 450, 460, 470, and/or 480 for review and revision by the review and revision process 200. A user may only need to select the desired sections for review by clicking on (e.g., through a digital interface or input device such as a mouse) the one or more sections 410, 420, 430, 440, 450, 460, 470, and/or 480. These selections and their respective content 415, 425, 435, 445, 455, 465, 475, and/or 485 may be incorporated into the order 202 a user submits to the electronic document system 100.

In certain aspects, the interface 400 may utilized at the output stage of the review and revision process 200 whereby a revised electronic document (e.g., the electronic document 402) that include the revisions made by the LM 230 is visually presented to the user. The user may interact with the revised electronic document in a manner similar to that of a word processing system to implement further review and revisions to the revised electronic document. In some aspects, the revisions made by the LM 230 may be depicted as tracked-changes in the revised electronic document so that the user may proceed with accepting or rejecting the updates. The electronic document 402 may be saved in any document format, such as PDF, DOCX, ODF, SVG, JPEG, and the like.

### Example Method for Reviewing and Revising an Electronic Document

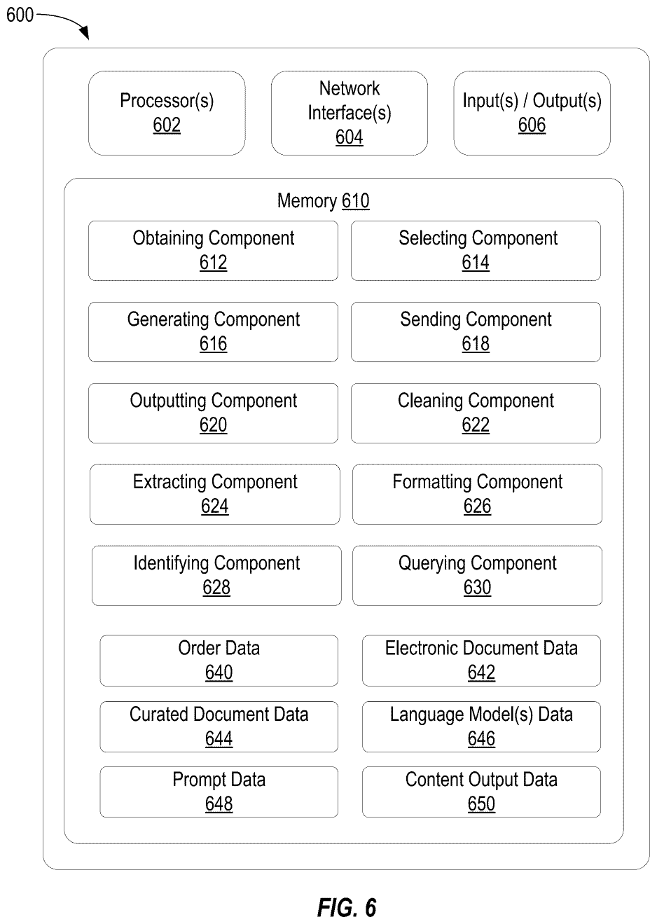

FIG. 5 depicts a flowchart of a method for electronic document review and revision. In some aspects, the method 500 may be performed by an apparatus, such as the first device 104 and/or the second device 106 of the electronic document system 100 depicted and described with reference to FIG. 1 and/or the electronic document apparatus 600 of FIG. 6.

Method 500 begins at block 505 with obtaining an electronic document comprising a plurality of sections of text. For example, block 505 may be performed by the electronic document system 100 described above with reference to FIG. 1 configured to receive order 204 for example through the document service API 206 as depicted and described with reference to FIG. 2.

Method 500 then proceeds to block 510 with, for one or more of the plurality of sections, selecting, from a plurality of sample electronic documents, a set of text samples corresponding to respective ones of the plurality of sections. For example, block 510 may be performed by the electronic document system 100 described above with reference to FIG. 1 configured to implement the text sample component 218 as depicted and described with reference to FIG. 2.

Method 500 then proceeds to block 515 with generating a prompt to guide a language model, wherein the prompt comprises: the set of text samples corresponding to the respective ones of the plurality of sections, target text associated with the respective ones of the plurality of sections, and instructions for the language model to review the target text based on the set of text samples. For example, block 515 may be performed by the electronic document system 100 described above with reference to FIG. 1 configured to implement the prompt generator component 216 as depicted and described with reference to FIG. 2.

Method 500 then proceeds to block 520 with sending, to the language model, the prompt. For example, block 520 may be performed by the electronic document system 100 described above with reference to FIG. 1 configured to send the prompt 217 generated by the prompt generator component 216 as depicted and described with reference to FIG. 2 to the LM 230.

Method 500 then proceeds to block 525 with obtaining, from the language model, a response based the prompt. For example, block 525 may be performed by the electronic document system 100 described above with reference to FIG. 1 configured to implement the LM 230 as depicted and described with reference to FIG. 2 based on the prompt 217.

Method 500 then proceeds to block 530 with outputting, to a user device, one or more revisions to the target text based on the response. For example, block 530 may be performed by the electronic document system 100 described above with reference to FIG. 1 configured to output the content output 240 as depicted and described with reference to FIG. 2, for example to the interface 300 or the interface 400 as depicted and described with reference to FIGS. 3-4.

In some aspects, method 500 may further include cleaning the electronic document with one or more text-cleaning components to optimize text of one of the plurality of sections of text for the language model.

In some aspects, method 500 may further include, for each of the respective ones of the plurality of sections, extracting the target text from the electronic document.

In some aspects, method 500 may further include obtaining a document identifier and a user identifier from the user device, and wherein block 505 includes extracting the electronic document from a document service API based on the document identifier and the user identifier.

In some aspects, method 500 may further include formatting the one or more revisions into a document template corresponding to a document type of the electronic document.

In some aspects, block 510 includes: identifying a section title corresponding to a respective one of the plurality of sections; querying the plurality of sample electronic documents for text from sections having a title corresponding to the section title; and extracting the text from a subset of the plurality of sample electronic documents based on the querying for the text from the plurality of sample electronic documents to obtain the set of text samples.

In some aspects, block 510 includes randomly selecting the set of text samples from a plurality of text samples.

In some aspects, the electronic document is a resume and the plurality of sections of text correspond to at least one of a summary text, a skills text, or a work history text.

In some aspects, the instructions of the prompt comprise one or more commands to execute a few-shot learning process based on the set of text samples corresponding to the respective ones of the plurality of sections.

In some aspects, the set of text samples comprise models of at least one of a writing style or a writing tone defined for the respective ones of the plurality of sections.

In some aspects, the one or more revisions to the target text correspond to respective ones of the plurality of sections.

In some aspect, method 500, or any aspect related to it, may be performed by an apparatus, such as the electronic document system 100 depicted and described with reference to FIG. 1 and/or the electronic document apparatus 600 of FIG. 6, which includes various components operable, configured, or adapted to perform the method 500. Example electronic document apparatus 600 is described below in further detail.

Method 500 thus provides technical solutions to overcome shortcomings of current document review and revision processes, for example, that rely on human personnel to complete review and revision of documents. Method 500 enables a user to request and obtain review and suggested revisions to an electronic document in real-time or near-real time. Real-time or near-real time review and revision of the electronic document is enabled through the implementation of one or more language models that are guided by selected text samples that tailor review and revision suggestions. The approach of guiding a language model to carry out review and revision of an electronic document based on selected text samples enables the language model to ascertain content, formatting, writing style, tone, and/or the like to apply during review and revision of the electronic document without defining specific rules for the language model to follow when reviewing and revising the electronic document. The described aspects provide flexibility, scalability, and customization to the use of language models in review and revisions processes through in-context learning techniques based on the selected text samples. The described aspects thereby provide the technical benefit of implementing customizable processes, such as review and revision of an electronic document for use submission to a desired job application, with a language model that does not require the large computational and time resources required for training and re-training a language model to perform the task.

Note that FIG. 5 is just one example of a method, and other methods including fewer, additional, or alternative operations are possible consistent with this disclosure.

### Example Electronic Document Apparatus

FIG. 6 depicts an example electronic document apparatus 600 configured to perform methods described herein. The example electronic document apparatus 600 depicted in FIG. 6 may be the first device 104 and/or the second device 106 of the electronic document system 100 depicted and described herein and with reference to FIG. 1.

The example electronic document apparatus 600 includes one or more processors 602. Generally, processor(s) 602 may be configured to execute computer-executable instructions (e.g., software code) to perform various functions, as described herein.

The example electronic document apparatus 600 further includes a network interface(s) 604, which generally provides data access to any sort of data network, including personal area networks (PANs), local area networks (LANs), wide area networks (WANs), the Internet, and the like.

The example electronic document apparatus 600 further includes input(s) and output(s) 606, which generally provide means for providing data to and from the example electronic document apparatus 600, such as via connection to computing device peripherals, including user interface peripherals.

The example electronic document apparatus 600 further includes a memory 610 configured to store various types of components and data.

In this example, memory 610 includes an obtaining component 612, selecting component 614, generating component 616, sending component 618, outputting component 620, cleaning component 622, extracting component 624, formatting component 626, identifying component 628, and querying component 630.

Obtaining component 612 may be configured to perform processes, for example, corresponding to block 505 and block 525 of method 500 depicted and described with reference to FIG. 5. Selecting component 614 may be configured to perform processes, for example, corresponding to block 510 of method 500 depicted and described with reference to FIG. 5. Generating component 616 may be configured to perform processes, for example, corresponding to block 515 of method 500 depicted and described with reference to FIG. 5. Sending component 618 may be configured to perform processes, for example, corresponding to block 520 of method 500 depicted and described with reference to FIG. 5. Outputting component 620 may be configured to perform processes, for example, corresponding to block 530 of method 500 depicted and described with reference to FIG. 5.

In this example, memory 610 also includes order data 640 (e.g., order 202), electronic document data 642 (e.g., a resume, cover letter, a job application, or the like), curated document data 644 (e.g., the plurality of sample electronic documents 112), Language model(s) data 646, prompt data 648 (e.g., the prompt 217), and content output data 650 (e.g., content output 240).

The example electronic document apparatus 600 may be implemented in various ways. For example, the example electronic document apparatus 600 may be implemented within on-site, remote, or cloud-based computing devices.

The example electronic document apparatus 600 is just one example, and other configurations are possible. For example, in alternative embodiments, aspects described with respect to the example electronic document apparatus 600 may be omitted, added, or substituted for alternative aspects.

### Example Clauses

Implementation examples are described in the following numbered clauses:

Clause 1: A method for document review, comprising: obtaining an electronic document comprising a plurality of sections of text; for one or more of the plurality of sections, selecting, from a plurality of sample electronic documents, a set of text samples corresponding to respective ones of the plurality of sections; generating a prompt to guide a language model, wherein the prompt comprises: the set of text samples corresponding to the respective ones of the plurality of sections, target text associated with the respective ones of the plurality of sections, and instructions for the language model to review the target text based on the set of text samples; sending, to the language model, the prompt; obtaining, from the language model, a response based the prompt; and outputting, to a user device, one or more revisions to the target text based on the response.

Clause 2: The method of Clause 1, further comprising cleaning the electronic document with one or more text-cleaning components to optimize text of one of the plurality of sections of text for the language model.

Clause 3: The method of any one of Clauses 1-2, further comprising, for each of the respective ones of the plurality of sections, extracting the target text from the electronic document.

Clause 4: The method of any one of Clauses 1-3, further comprising obtaining a document identifier and a user identifier from the user device, and wherein obtaining the electronic document further comprises extracting the electronic document from a document service API based on the document identifier and the user identifier.

Clause 5: The method of any one of Clauses 1-4, further comprising formatting the one or more revisions into a document template corresponding to a document type of the electronic document.

Clause 6: The method of any one of Clauses 1-5, wherein selecting the set of text samples comprises: identifying a section title corresponding to a respective one of the plurality of sections; querying the plurality of sample electronic documents for text from sections having a title corresponding to the section title; and extracting the text from a subset of the plurality of sample electronic documents based on the querying for the text from the plurality of sample electronic documents to obtain the set of text samples.

Clause 7: The method of any one of Clauses 1-6, wherein selecting the set of text samples further comprises randomly selecting the set of text samples from a plurality of text samples.

Clause 8: The method of any one of Clauses 1-7, wherein the electronic document is a resume and the plurality of sections of text correspond to at least one of a summary text, a skills text, or a work history text.

Clause 9: The method of any one of Clauses 1-8, wherein the instructions of the prompt comprise one or more commands to execute a few-shot learning process based on the set of text samples corresponding to the respective ones of the plurality of sections.

Clause 10: The method of any one of Clauses 1-9, wherein the set of text samples comprise models of at least one of a writing style or a writing tone defined for the respective ones of the plurality of sections.

Clause 11: The method of any one of Clauses 1-10, wherein the one or more revisions to the target text correspond to respective ones of the plurality of sections.

Clause 12: A processing system, comprising means for performing a method in accordance with any one of Clauses 1-11.

Clause 13: A non-transitory computer-readable medium comprising computer-executable instructions that, when executed by a processor of a processing system, cause the processing system to perform a method in accordance with any one of Clauses 1-11.

Clause 14: A computer program product embodied on a computer-readable storage medium comprising code for performing a method in accordance with any one of Clauses 1-11.

### Additional Considerations

The description provided above is intended to be illustrative and non-limiting. Thus, it will be apparent to one skilled in the art that modifications may be made to the present disclosure as described without departing from the scope of the claims set out below. Moreover, while the above description was provided with reference to the creation of enhanced documents and online documents, the disclosure is not thus limited, and may be naturally extended to other contexts.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various aspects of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary aspects, but should be defined only in accordance with the following claims and their equivalents.

What is claimed is:

1. A method for electronic document review, comprising:
obtaining an electronic document comprising a plurality of sections of text;
for one or more of the plurality of sections, selecting, from a plurality of sample electronic documents, a set of text samples corresponding to respective ones of the plurality of sections;
generating a prompt to guide a language model, wherein the prompt comprises:
the set of text samples corresponding to the respective ones of the plurality of sections,
target text associated with the respective ones of the plurality of sections, and
instructions for the language model to review the target text based on the set of text samples;
sending, to the language model, the prompt;
obtaining, from the language model, a response based the prompt; and
outputting, to a user device, one or more revisions to the target text based on the response.

2. The method of claim 1, further comprising cleaning the electronic document with one or more text-cleaning components to optimize text of one of the plurality of sections of text for the language model.

3. The method of claim 1, further comprising for each of the respective ones of the plurality of sections, extracting the target text from the electronic document.

4. The method of claim 1, further comprising obtaining a document identifier and a user identifier from the user device, and wherein obtaining the electronic document further comprises extracting the electronic document from a document service application programming interface (API) based on the document identifier and the user identifier.

5. The method of claim 1, further comprising formatting the one or more revisions into a document template corresponding to a document type of the electronic document.

6. The method of claim 1, wherein selecting the set of text samples comprises:
identifying a section title corresponding to a respective one of the plurality of sections;
querying the plurality of sample electronic documents for text from sections having a title corresponding to the section title; and
extracting the text from a subset of the plurality of sample electronic documents based on the querying for the text from the plurality of sample electronic documents to obtain the set of text samples.

7. The method of claim 1, wherein selecting the set of text samples further comprises randomly selecting the set of text samples from a plurality of text samples.

8. The method of claim 1, wherein the electronic document is a resume and the plurality of sections of text correspond to at least one of a summary text, a skills text, or a work history text.

9. The method of claim 1, wherein the instructions of the prompt comprise one or more commands to execute a few-shot learning process based on the set of text samples corresponding to the respective ones of the plurality of sections.

10. The method of claim 1, wherein the set of text samples comprise models of at least one of a writing style or a writing tone defined for the respective ones of the plurality of sections.

11. The method of claim 1, wherein the one or more revisions to the target text correspond to respective ones of the plurality of sections.

12. A processing system, comprising:
one or more memories comprising computer-executable instructions; and
one or more processors configured to execute the computer-executable instructions causing the processing system to:
obtain an electronic document comprising plurality of sections of text;
for one or more of the plurality of sections, select, from a plurality of sample electronic documents, a set of text samples corresponding to respective ones of the plurality of sections;
generate a prompt to guide a language model, wherein the prompt comprises:
the set of text samples corresponding to the respective ones of the plurality of sections,
target text associated with the respective ones of the plurality of sections, and
instructions for the language model to review the target text based on the set of text samples;
send, to the language model, the prompt;
obtain, from the language model, a response based the prompt; and
output, to a user device, one or more revisions to the target text based on the response.

13. The processing system of claim 12, wherein the processing system is further configured to clean the electronic document with one or more text-cleaning components to optimize text of one of the plurality of sections of text for the language model.

14. The processing system of claim 12, wherein the processing system is further configured to for each of the respective ones of the plurality of sections, extract the target text from the electronic document.

15. The processing system of claim 12, wherein the processing system is further configured to obtain a document identifier and a user identifier from the user device, and wherein obtaining the electronic document further comprises extracting the electronic document from a document service application programming interface (API) based on the document identifier and the user identifier.

16. The processing system of claim 12, wherein the processing system is further configured to format the one or more revisions into a document template corresponding to a document type of the electronic document.

17. The processing system of claim 12, wherein to select the set of text samples comprises:
identifying a section title corresponding to a respective one of the plurality of sections;
querying the plurality of sample electronic documents for text from sections having a title corresponding to the section title; and
extracting the text from a subset of the plurality of sample electronic documents based on the querying for the text from the plurality of sample electronic documents to obtain the set of text samples.

18. The processing system of claim 12, wherein the instructions of the prompt comprise one or more commands to execute a few-shot learning process based on the set of text samples corresponding to the respective ones of the plurality of sections.

19. The processing system of claim 12, wherein the set of text samples comprise models of at least one of a writing style or a writing tone defined for the respective ones of the plurality of sections.

20. The processing system of claim 12, wherein the one or more revisions to the target text correspond to respective ones of the plurality of sections.
